(19) United States
(12) Patent Application Publication
(10) Pub. No.: US 2019/0228481 A1
(43) Pub. Date: Jul. 25, 2019

(54) INTELLIGENT ENERGY MANAGEMENT SYSTEM FOR DISTRIBUTED ENERGY RESOURCES AND ENERGY STORAGE SYSTEMS USING MACHINE LEARNING

(71) Applicant: Pason Power Inc., Calgary (CA)

(72) Inventors: PRUDHVI TELLA, Houston, TX (US); JIELIAN GUO, Katy, TX (US); ENRICO LADENDORF, Houston, TX (US); MATTHEW JOEL HICKS, Cypress, TX (US)

(21) Appl. No.: 16/251,764

(22) Filed: Jan. 18, 2019

Related U.S. Application Data
(60) Provisional application No. 62/620,374, filed on Jan. 22, 2018.

(51) Int. Cl. G06Q 50/06; G06N 20/00

(52) U.S. Cl. CPC G06Q 50/06; G06N 20/00

(57) ABSTRACT

There is provided a method for managing electricity demand, the method comprising: obtaining past demand data of a site, the past demand data comprising past electricity usage data representing electricity usage at the site over a past time period extending from a past point in time to a current point in time; determining, based on the past demand data, projected electricity usage data of the site by inputting the past demand data to a trained machine learning model comprised in a set of one or more trained machine learning models, the projected electricity usage data representing projected electricity usage at the site over a future time period, and wherein the future time period does not comprise a period of time at least twenty-three hours from the current point in time; determining one or more peak demand periods when, during the future time period, the projected electricity usage at the site exceeds a demand threshold; and securing non-grid electricity for use by the site during the one or more peak demand periods.

This application claims priority to U.S. Patent Appln. No. 62/620,374, filed Jan. 22, 2018 the contents of all incorporated herewith.

### FIELD OF THE DISCLOSURE

The present disclosure relates to methods and systems for managing electricity demand, and in particular for managing peaks in electricity demand.

### BACKGROUND TO THE DISCLOSURE

Commercial and industrial (C&I) sites pay for power differently when compared to residential sites. In particular, C&I sites are generally billed for both their total energy consumption and their peak power demand, referred to as a “demand charge”. FIG. 1 shows a typical electricity demand profile of a C&I site, also known as a demand charge profile. The profile comprises a substantially steady-state portion 12 and peaks 14 extending from steady-state portion 12 above a demand threshold 16.

Demand charges exist as a mechanism for utilities to cover the costs of delivering the desired level of energy to customers. Each customer is assigned to a particular “rate tariff” which defines how demand charges are measured and assessed for that customer. While details of rate tariffs can vary from utility to utility, the demand charge is generally based on the maximum energy a site consumed during a time interval (for example 15 minutes or 1 hour) during the previous billing cycle.

While there have been many advances in energy efficiency to enable C&I customers to reduce their energy consumption, until recently there have been few technologies for reducing the demand charge component of a customer's incurred cost. Furthermore, while energy prices have remained low in recent years, demand charges have been on the rise and are expected to continue to rise into at least the near future.

This presents the opportunity to minimize the demand charge component of the customer's incurred cost, referred to as “demand charge management”. Not only does demand charge management reduce the customer's electricity bill, but it reduces risks associated with unmanaged peak loads and demand charge price escalation as rate tariffs are updated.

Non-grid electricity supplies, such as energy storage systems, have emerged as a technology which can enable demand charge management through a process known as “peak shaving”. The basic process of peak shaving is accomplished by storing (charging) energy in an energy storage system at times of low energy demand, and discharging the stored energy at times of high energy demand.

The process of creating an accurate prediction of a site's future load is difficult and complex, as energy usage patterns can be highly variable from one site to another, can vary greatly based on numerous factors including the time of day, the day of the week, the day of the year, weather, building type, work schedule, business processes, etc. It would therefore be advantageous if future energy demands could be better anticipated, so that non-grid electricity supply may be better managed for use during the peak demands.

The present disclosure seeks to provide methods and systems that provide improved management of electricity demand charge, in view of at least some of the deficiencies encountered in the prior art.

### SUMMARY OF THE DISCLOSURE

In a first aspect of the disclosure, there is provided a method for managing electricity demand. The method comprises obtaining past demand data of a site, the past demand data comprising past electricity usage data representing electricity usage at the site over a past time period extending from a past point in time to a current point in time. The method further comprises determining, based on the past demand data, projected electricity usage data of the site, the projected electricity usage data representing projected electricity usage at the site over a future time period. The method further comprises determining one or more peak demand periods when, during the future time period, the projected electricity usage at the site exceeds a demand threshold. The method further comprises securing non-grid electricity for use by the site during the one or more peak demand periods. In some embodiments, the future time period does not comprise a period of time at least twenty-three hours from the current point in time. The future time period may be selected by a user, and may be inputted to the trained machine learning model with the past demand data.

Determining the projected electricity usage data may comprise inputting the past demand data to a trained machine learning model. The trained machine learning model may be configured to determine projected electricity usage data for a first time slot that immediately follows the current point in time. The set of trained machine learning models may comprise multiple trained machine learning models, and each other trained machine learning model may be configured to determine projected electricity usage data for a respective time slot that immediately follows a preceding one of the time slots.

The trained machine learning model to which is inputted the past demand data may depend on the future time period. For example, in one embodiment, if the current point in time is 12 PM and a user wishes to forecast projected electricity usage for 3 PM-4 PM later that day, then a trained machine learning model configured to forecast up to 4 hours in the future is used (using data prior to and up to 12 PM). However, if the current point in time is 2 PM and the user wishes to forecast projected electricity usage for 3 PM-4 PM, then a (different) trained machine learning model configured to forecast up to 2 hours in the future is used (using data prior to and up to 2 PM).

Prior to obtaining the past demand data, the method may further comprise obtaining demand training data, the demand training data comprising electricity training data representing electricity usage at the site over a training time period greater than the past time period. Prior to obtaining the past demand data, the method may further comprise training the machine learning model, using the demand training data, to project electricity usage at the site over first time periods as a function of electricity usage at the site over second time periods preceding the first time periods.

The demand training data may further comprise data representing one or more of: weather; temperature; humidity; atmospheric pressure; months of a year; time of day; dates; days of a week; and whether or not a day of the week is a site holiday.

The demand threshold may comprise a first demand threshold above which are located one or more peaks in the projected electricity usage

Each machine learning model may comprise one or more support vector machines or a long short-term memory model.

The past time period may comprise twenty-four hours. In some embodiments the past time period could be a one-week period into the past starting from the end of the future time period. The future time period may comprise one or more 15-minute time slots of twenty-four hours.

The non-grid electricity may comprise electricity to be drawn from one or more batteries or from one or more photovoltaic cells.

The past demand data may further comprise data representing one or more of: weather; temperature; humidity; atmospheric pressure; date; time; and the future time period.

The method may further comprise determining, based on the projected electricity usage data, whether to recharge one or more batteries using grid electricity or electricity to be drawn from one or more photovoltaic cells.

The method may further comprise determining, based on the projected electricity usage data, from which of multiple non-grid electricity sources to secure the non-grid electricity.

The non-grid electricity may comprise electricity to be drawn from one or more batteries.

The non-grid electricity may comprise electricity to be drawn from one or more photovoltaic cells.

Determining whether to recharge the one or more batteries may be further based on an amount of charge remaining in the one or more batteries.

In a further aspect of the disclosure, there is provided a method for training a machine learning model. The method comprises receiving at a machine learning model demand training data, the demand training data comprising electricity usage training data representing past electricity usage at a site over a training time period. The method further comprises training the machine learning model, using the demand training data, to project electricity usage at the site over one or more first time periods as a function of electricity usage at the site over one or more second time periods that precede the one or more first time periods.

In a further aspect of the disclosure, there is provided a demand management system for managing electricity demand. The system comprises one or more non-grid electricity sources; and a control system comprising one or more processors and memory having stored thereon computer program code configured, when executed by the one or more processors, to cause the one or more processors to perform a method. The method comprises obtaining past demand data of a site, the past demand data comprising past electricity usage data representing electricity usage at the site over a past time period extending from a past point in time to a current point in time. The method further comprises determining, based on the past demand data, projected electricity usage data of the site, the projected electricity usage data representing projected electricity usage at the site over a future time period. The method further comprises determining one or more peak demand periods when, during the future time period, the projected electricity usage at the site exceeds a demand threshold. The method further comprises securing, from the one or more non-grid electricity sources, non-grid electricity for use by the site during the one or more peak demand periods. In some embodiments, the future time period does not comprise a period of time at least twenty-three hours from the current point in time.

The method may comprise any of the features described above in connection with the first aspect of the disclosure.

In a further aspect of the disclosure, there is provided a computer-readable medium having stored thereon computer program code configured, when executed by one or more processors, to cause the one or more processors to perform a method. The method comprises obtaining past demand data of a site, the past demand data comprising past electricity usage data representing electricity usage at the site over a past time period extending from a past point in time to a current point in time. The method further comprises determining, based on the past demand data, projected electricity usage data of the site, the projected electricity usage data representing projected electricity usage at the site over a future time period. The method further comprises determining one or more peak demand periods when, during the future time period, the projected electricity usage at the site exceeds a demand threshold. The method further comprises securing non-grid electricity for use by the site during the one or more peak demand periods. In some embodiments, the future time period does not comprise a period of time at least twenty-three hours from the current point in time.

The method may comprise any of the features described above in connection with the first aspect of the disclosure.

In a further aspect of the disclosure, there is provided a computer-readable medium having stored thereon computer program code configured, when executed by one or more processors, to cause the one or more processors to perform a method. The method comprises receiving at a machine learning model demand training data, the demand training data comprising electricity usage training data representing past electricity usage at a site over a training time period. The method further comprises training the machine learning model, using the demand training data, to project electricity usage at the site over one or more first time periods as a function of electricity usage at the site over one or more second time periods that precede the one or more first time periods.

In a further aspect of the disclosure, there is provided a method for managing electricity demand, the method comprising: obtaining past demand data of a site, the past demand data comprising past electricity usage data representing electricity usage at the site over a past time period; determining, based on the past demand data, projected electricity usage data of the site by inputting the past demand data to a trained machine learning model configured to determine projected electricity usage data for a future time period that immediately follows the current point in time, the projected electricity usage data representing projected electricity usage at the site over the future time period; determining one or more peak demand periods when, during the future time period, the projected electricity usage at the site exceeds a demand threshold; and securing non-grid electricity for use by the site during the one or more peak demand periods.

The method may comprise any of the features described above in connection with the first aspect of the disclosure.

In a further aspect of the disclosure, there is provided a demand management system for managing electricity demand, the system comprising: one or more non-grid electricity sources; and a control system comprising one or more processors and memory having stored thereon computer program code configured, when executed by the one or more processors, to cause the one or more processors to perform a method comprising: obtaining past demand data of a site, the past demand data comprising past electricity usage data representing electricity usage at the site over a past time period; determining, based on the past demand data, projected electricity usage data of the site by inputting the past demand data to a trained machine learning model configured to determine projected electricity usage data for a future time period that immediately follows the current point in time, the projected electricity usage data representing projected electricity usage at the site over the future time period; determining one or more peak demand periods when, during the future time period, the projected electricity usage at the site exceeds a demand threshold; and securing, from the one or more non-grid electricity sources, non-grid electricity for use by the site during the one or more peak demand periods.

The method may comprise any of the features described above in connection with the first aspect of the disclosure.

In a further aspect of the disclosure, there is provided a computer-readable medium having stored thereon computer program code configured, when executed by one or more processors, to cause the one or more processors to perform a method comprising: obtaining past demand data of a site, the past demand data comprising past electricity usage data representing electricity usage at the site over a past time period; determining, based on the past demand data, projected electricity usage data of the site by inputting the past demand data to a trained machine learning model configured to determine projected electricity usage data for a future time period that immediately follows the current point in time, the projected electricity usage data representing projected electricity usage at the site over the future time period; determining one or more peak demand periods when, during the future time period, the projected electricity usage at the site exceeds a demand threshold; and securing non-grid electricity for use by the site during the one or more peak demand periods.

The method may comprise any of the features described above in connection with the first aspect of the disclosure.

### BRIEF DESCRIPTION OF THE DRAWINGS

Detailed embodiments of the disclosure will now be described in connection with the accompanying drawings of which:

FIG. 1 shows a typical demand charge profile of a commercial/industrial site;

FIG. 2 is a schematic diagram of a power management system in accordance with an embodiment of the disclosure;

FIG. 3 is a more detailed schematic diagram of the power management system of FIG. 2;

FIG. 4 is an example of a long short-term memory model in accordance with embodiments of the disclosure;

FIG. 5 is a flow diagram showing a method of managing electricity demand, in accordance with an embodiment of the disclosure; and

FIGS. 6A and 6B are examples of feature vectors in accordance with embodiments of the disclosure.

### DETAILED DESCRIPTION

The present disclosure seeks to provide methods and systems for managing electricity demand. While various embodiments of the disclosure are described below, the disclosure is not limited to these embodiments, and variations of these embodiments may well fall within the scope of the disclosure which is to be limited only by the appended claims.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As will be appreciated by one skilled in the art, the various example embodiments described herein may be embodied as a method, system, or computer program product. Accordingly, the various example embodiments may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the various example embodiments may take the form of a computer program product on a computer-usable storage medium having computer-usable program code embodied in the medium.

Any suitable computer-usable or computer readable medium may be used. The computer-usable or computer-readable medium may be, for example but not limited to, an electronic, magnetic, optical, electromagnetic, infrared, or semiconductor system, apparatus, device, or propagation medium. In the context of this document, a computer-usable or computer-readable medium may be any medium that can contain, store, communicate, propagate, or transport the program for use by or in connection with the instruction execution system, apparatus, or device.

Computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or entirely on the remote computer or server. In the latter scenario, the remote computer may be connected to the computer through a local area network (LAN) or a wide area network (WAN), or the connection may be made to an external computer (for example, through the Internet using an Internet Service Provider).

Various example embodiments are described below with reference to flow diagrams and/or block diagrams of methods, apparatus (systems) and computer program products according to example embodiments. It will be understood that each block of the flow diagrams and/or block diagrams, and combinations of blocks in the flow diagrams and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flow diagram and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flow diagram and/or block diagram block or blocks.

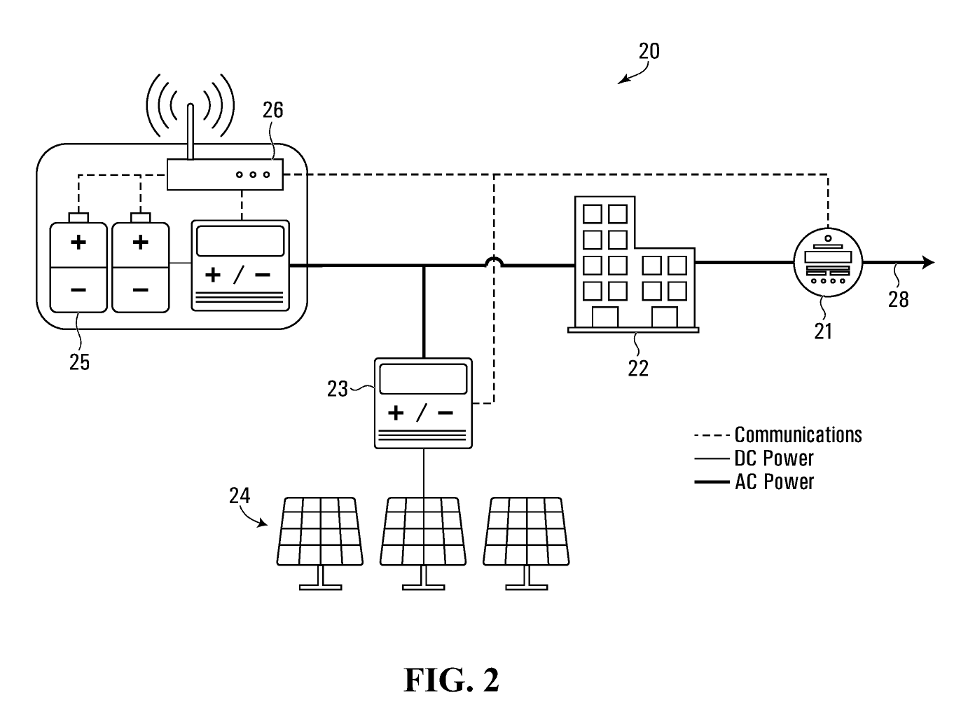

With reference to FIG. 2, there is shown a demand management system 20 used for managing electricity demand of a site 22, in accordance with an embodiment of the disclosure. Site 22 is electrically coupled to photovoltaic cells 24 via one or more inverters 23. Site 22 is further electrically coupled to an electricity grid 28 configured to provide electricity on demand to site 22. One or more meters 21 are configured to monitor a consumption of electricity at site 22. Site 22 is further coupled to an energy management system processor 26 (described in further detail below) and batteries 25 configured to provide stored electrical energy to site 22. Batteries 25 are further electrically coupled to photovoltaic cells 24 for recharging of batteries 25.

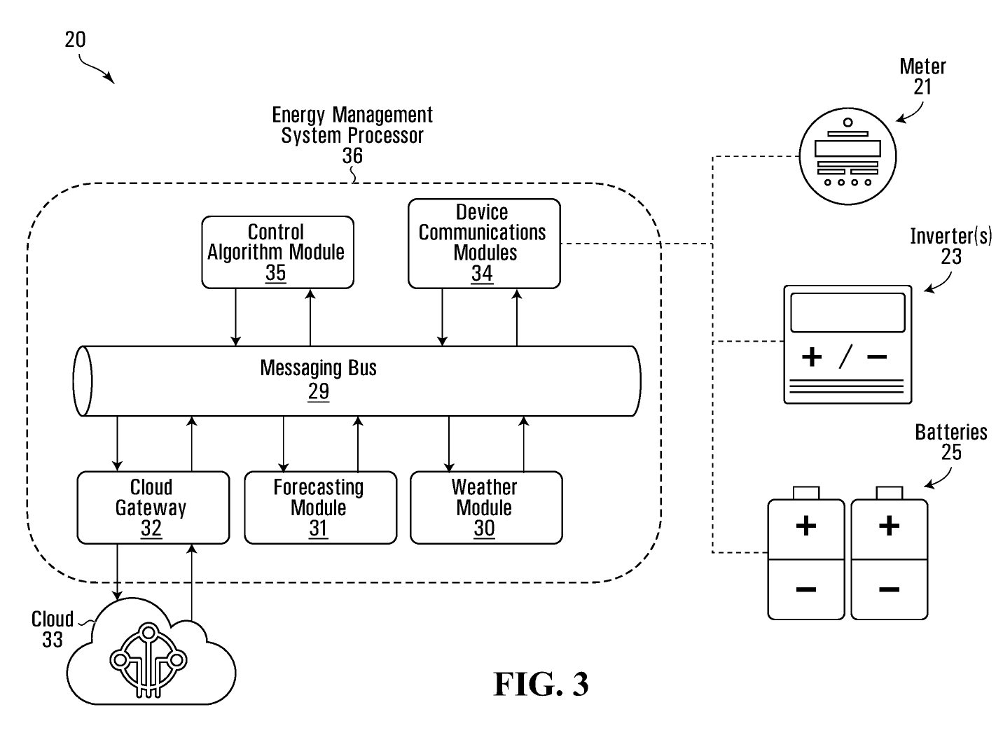

FIG. 3 shows another schematic representation of demand management system 20, this time showing communicative pathways between the various components of demand management system 20. Meters 21, inverters 23, and batteries 25 are communicatively coupled to one or more device communications modules 34 such that data from meters 21, inverters 23, and batteries 25 may be communicated to a messaging bus 29 via device communications modules 34. Also communicatively coupled to messaging bus 29 are a weather module 30 and a forecasting module 31. Energy management system processor 26 is seen to comprise a control algorithm module 35, device communications modules 34, cloud gateway 32, forecasting module 31, weather module 30, and messaging bus 29, although in other embodiments it shall be understood that energy management system processor 26 may comprise more or fewer modules.

Data from weather module 30 and forecasting module 31 may be transmitted along messaging bus 29 to control algorithm module 35. The data transmitted from weather module 30 comprises any weather-related data which may have been forecasted by weather module 30 using methods known to those of skill in the art, or which may have been provided directly to weather module 30 without weather module 30 performing the forecasting of the weather. Control algorithm module 35 comprises one or more processors communicative with memory having computer program code stored thereon. The program code is configured, when executed by the one or more processors, to perform any of the methods described herein. In particular, control algorithm module 35 is configured to implement one or more peak shaving algorithms, as described herein. Control algorithm module 35 may use data received from other components of demand management system 20, such as inverters 23, batteries 25, and forecasting module 31, in order to effectively implement the one or more peak shaving algorithms. Forecasting module 31 contains a machine learning model that is used for forecasting a future load (i.e. projected or expected electricity usage) at site 22, as described in further detail below.

In order to manage the electricity demand at site 22, control algorithm module 35 communicates with forecasting module 31 which is configured to apply a trained machine learning model to a set of past demand data in order to forecast a future load at site 22. The past demand data comprises, amongst other data, past electricity usage data at site 22. As described below, the machine learning model is trained using demand training data which comprises electricity usage training data. The machine learning model may be trained by forecasting module 31 itself or alternatively the trained machine learning model may be downloaded to forecasting module 31, for example via cloud gateway 32 communicating with an external cloud 33. Thus, the machine learning model may be trained externally to demand management system 20, and subsequently obtained by control algorithm module 35 through forecasting module 31.

The machine learning model may be any machine learning model suitable for the purposes described herein. In some embodiments, the machine learning model is a support vector regression (SVR) model. In other embodiments, the machine learning model is a long short-term memory (LSTM) model. Examples of an SVR model and an LSTM model that may be employed by forecasting module 31 are described below.

In a supervised regression problem, the training data is taken as {(x₁, . . . , y₁), . . . , (xₗ, . . . , yₗ)}⊂ [symbol] × [symbol] , where [symbol] denotes the space of the input patterns, for instance [symbol] ^{d}. In ε−SV regression, the goal is to find a function ƒ(x) that has at most ε deviation from the actually obtained targets yᵢ for all the training data, and which is at the same time as flat as possible. In the case of a linear function Λ,

ƒ(x)=<ω,x>+b with ωϵ [symbol] ,bϵ [symbol] (1),

where <. , .> denotes the dot product in [symbol] . Flatness in (1) implies small ω. In order to achieve flatness, it is required to minimize the Euclidean norm ∥ω∥². Formally, this can be written as a convex optimization problem by requiring:

$$minimize \frac{1}{2} {‖ ω ‖}^{2} \\ subject to \{ \begin{matrix}{y}_{i} - < ω , {x}_{i} > - b \leq ɛ \\ < ω , {x}_{i} > + b - {y}_{i} \leq ɛ\end{matrix} . \qquad ( 2 )$$

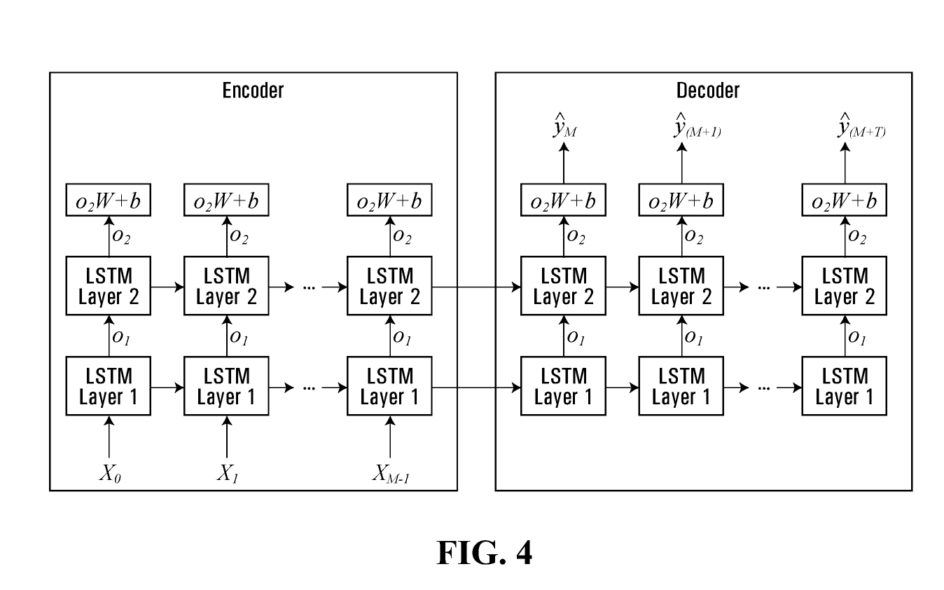

An example LSTM model is shown in FIG. 4. In FIG. 4, Xᵢ is a feature vector, and ŷᵢ is forecasted electricity usage. In the embodiment of FIG. 4, an example feature vector Xᵢ inputted to an LSTM model comprises past electricity usage y at time step i−1, weather at time step i, and date and time at time step i, as per the following:

Xᵢ=[yᵢ₋₁,weatherᵢ,date timeᵢ]

In order to train the machine learning model, a set of demand training data is used as an input to the machine learning model. The demand training data comprises data representing past electricity usage at site 22. The past electricity usage may be determined for example by periodically obtaining meter readings from meters 21. In addition to past electricity usage, the demand training data comprises data representing a number of other different parameters related to electricity usage at site 22 over a period of time. For example, the demand training data may comprise data representing any prevailing weather conditions at site 22, for example temperature, humidity, date and time information (for example information relating to time of day, day of the week, month, and whether not a day is a site holiday). Other parameters may form part of the demand training data. The demand training data is preferably obtained over a relatively long period of time, for example two years.

Inputting the demand training data to the machine learning model trains the machine learning model to forecast electricity usage at site 22 as a function of past electricity usage at site 22. In other words, the machine learning model is able to determine possible relationships between past electricity usage (including past weather conditions and date/time information) and future electricity usage, by analyzing the demand training data to determine trends within the demand training data. Once the machine learning model has been trained using the electricity usage training data, the trained machine learning model may be used to forecast future electricity usage at site 22, by using known, past demand usage data.

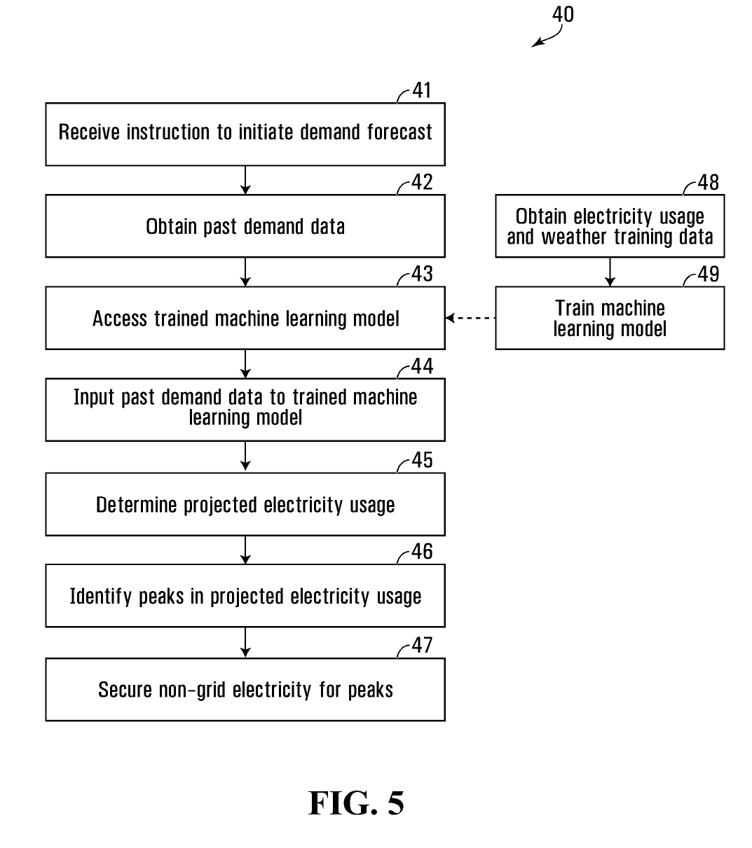

FIG. 5 is a flowchart showing operations that may be taken by energy management system processor (EMSP) 36 in managing electricity demand at site 22, by performing an electricity demand management method 40. At block 41, EMSP 36 receives an instruction from a user of demand management system 20 to initiate a demand forecast, by performing electricity demand management method 40. The instruction specifies a future time period over which forecasting module 31 is to forecast future electricity usage. At block 42, EMSP 36 obtains past demand data. The past demand data comprises past electricity usage data representing past electricity usage at site 22. The past electricity usage data may be obtained for example by periodically obtaining meter readings from meters 21. In addition to past electricity usage data, the past demand data comprises data representing a number of other different parameters related to electricity usage at site 22 over a period of time. For example, the past demand data comprises data representing any prevailing weather conditions at site 22, temperature (for example temperature of batteries 25 as well as ambient temperature), atmospheric humidity, atmospheric pressure, and date and time information representing the particular future time period the user wishes to forecast. Other parameters may form part of the past demand data.

In some embodiments, the past demand data represents data over a one-week period. In addition, the period of time corresponding to the past demand data extends from a past point in time to a current point in time. In other words, the period of time corresponding to the past demand data extends from a past point in time to the point in time at which EMSP 36 is instructed to carry out electricity demand management method 40. Thus, the past demand data may be obtained from a “rolling window” as time goes forward. In this manner, more recent demand data may be used as an input to the machine learning model, thereby improving the accuracy of the forecast.

At block 43, EMSP 36 accesses the trained machine learning model. As described above, the trained machine learning model may be downloaded to EMSP 36. Alternatively, the trained machine learning model may be stored on a device or devices external to EMSP 36, such that EMSP 36 sends the past demand data to the external device or devices for inputting to the trained machine learning model, and receives from the external device or devices output from the trained machine learning model. Blocks 48 and 49 represent respectively obtaining the demand training data, as described above, and training the machine learning model using the demand training data.

At block 44, the past demand data is inputted to the trained machine learning model. At block 45, the trained machine learning model outputs projected electricity usage data representing projected electricity usage at site 22 for the future time period selected by the user.

In some embodiments, the user may request a forecast of the expected or projected electricity usage at site 22 for any amount of time up to the following 24 hours, with a granularity of 15 minutes. Of course, in other embodiments the forecast may be extended to longer or smaller time horizons, with greater or smaller granularities. In order to perform the forecasting, in one embodiment the trained machine learning model uses 96 support vector machine (SVR) models. Each SVR model is configured to forecast projected electricity usage for a specific future time slot (i.e. a specific 15-minute tranche). For example, the first SVR model is used to forecast the immediately subsequent 15 minutes; in other words, the 15 minutes that follow the point in time that EMSP 36 is instructed to perform the forecast. The second SVR model is used to forecast the 15-30 minute time slot; in other words, the 15 minutes that follow a point in time 15 minutes after EMSP 36 is instructed to perform the forecast; etc. By integrating multiple ones of 96 forecasts of the 96 SVR models, a forecast horizon of 24 hours with 15-minute granularity may be generated. As mentioned above, the number of SVR models can be tuned to forecast for different time horizons, and with different granularity, and thus any number of SVR models may in practice be used to forecast projected electricity usage.

The past demand data is represented using feature vectors as described below. Let d denote the current day and j−1 denote the current time. The first SVR model is used to forecast the electricity usage of day d at time j−1+1. The second SVR model is used to forecast the electricity usage of day d at time j−1+2. More generally, the m^{th} SVR model is used to forecast the electricity usage of day d at time j−1+m. Each feature vector comprises data relating to one or more of the parameters identified above. For example, in addition to past electricity usage, each feature vector may comprise data relating to prevailing weather conditions at site 22, temperature (for example temperature of batteries 25 as well as ambient temperature), atmospheric humidity, atmospheric pressure, and date and time information representing the particular future time period the user wishes to forecast.

An example feature vector is shown below:

| | | | | | | | | |
|---|---|---|---|---|---|---|---|---|
| Load | cooling | heating | extra | humidity | day of | month | holiday | period to |
| | | | heating | | week | | | be |
| | | | | | | | | forecasted |

Take for example the past electricity usage of the m^{th} SVR model. The m^{th} SVR model uses as an input the load (past electricity usage) of time (j−1+m). Thus,

[load(0), load(1), . . . , load(15)] may be the load of day d−7 at time (j−1+m)−6, (j−1+m)−5, . . . , (j−1+m), (j−1+m)+1, . . . , (j−1+m)+9.

[load(16), load(17)] may be the load of day d−3 at time (j−1+m)−1, (j−1+m).

[load(18), load(19)] may be the load of day d−2 at time (j−1+m)−1, (j−1+m).

[load(20), load(21), load(25)] may be the load of day d−1 at time (j−1+m)−6, (j−1+m)−1, (j−1+m).

[load(26), load(27), . . . , load(121)] may be the load of day d at time j−96, j−95, j−2, j−1 (i.e. all the load/past electricity usage information of the past 24 hours).

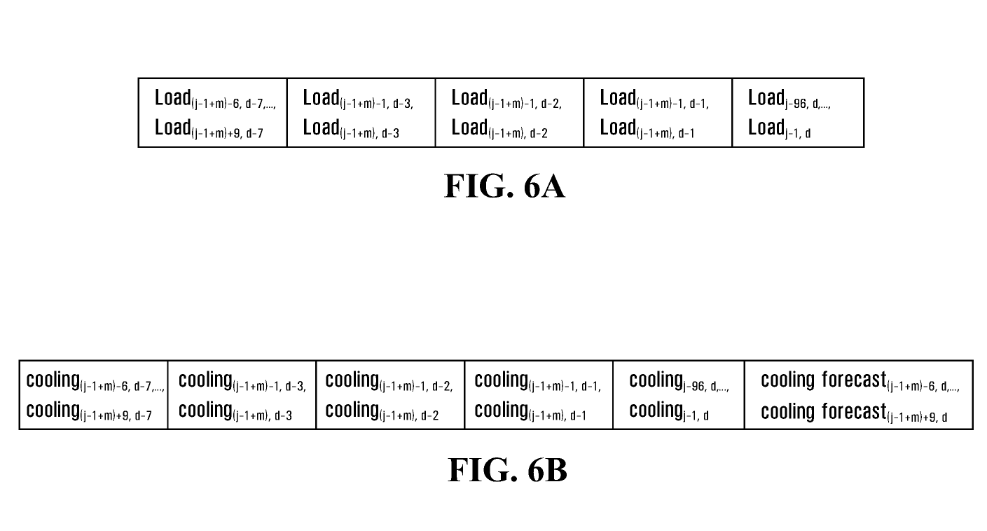

Examples of load and cooling data in feature vectors are shown in FIGS. 6A and 6B. Note that as mentioned above the feature vectors may comprise data relating to additional parameters (not shown in FIGS. 6A and 6B).

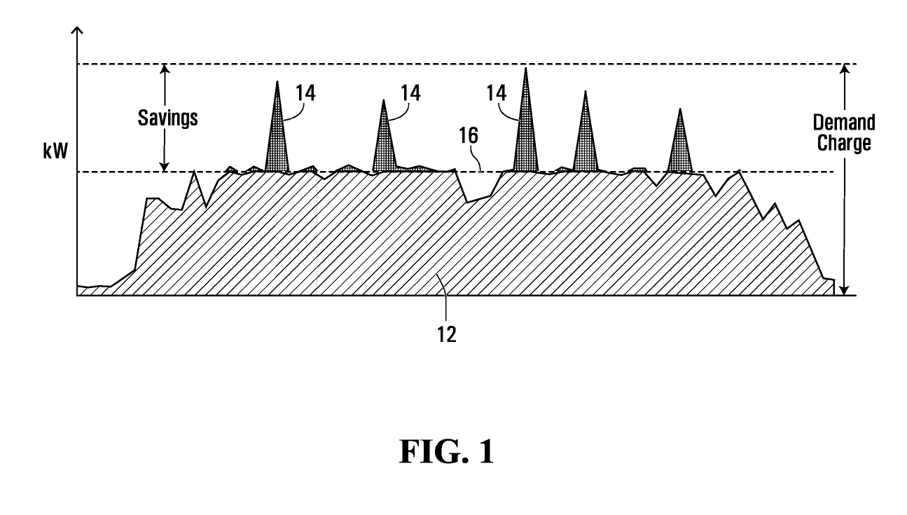

Once EMSP 36 has performed the forecast, at block 46, EMSP 36 identifies one or more peaks in the projected electricity usage. The peaks may be identified by comparing the projected electricity usage to an electricity demand threshold (for example electricity demand threshold 16 as can be seen in FIG. 1). There are various methods known in the art for identifying such peaks.

At block 47, EMSP 36 transmits one or more instructions for securing non-grid electricity for managing the projected electricity demand. In particular, EMSP 36 transmits one or more instructions for securing non-grid electricity for use during the future periods corresponding to the identified peaks. Non-grid electricity may be derived from various distributed energy/electricity resources, such as batteries 25 and/or photovoltaic cells 24, or other on-site energy generation (such as combined heat and power generation, or from a diesel/gas generator). During relatively steady-state electricity usage (such as during the period corresponding to steady-state demand 12 in FIG. 1), grid-based electricity may be used when needed. However, during periods of peak power demand (such as during the periods corresponding to peaks 14 in FIG. 1), electricity from non-grid sources may be used so as to reduce the overall cost to the site owner.

EMSP 36 may be configured to take into account current electricity reserves in non-grid sources, such as in batteries 25 and/or photovoltaic cells 24, before determining from which non-grid source(s) to draw stored electricity so as to perform peak shaving. Furthermore, EMSP 36 may use the past demand data to determine the non-grid source for use during the periods of peak demand. In particular, the past demand data may also comprise data representing battery and photovoltaic cell storage over a past time period. Using the trained machine learning model, EMSP 36 may determine from the past demand data projected battery and photovoltaic cell storage over a future time period. Thus, by using past battery and photovoltaic cell storage data, EMSP 36 may predict future battery and photovoltaic cell storage. This information may be used by EMSP 36 to better anticipate from which non-grid source electricity is to be used for shaving the peaks, based on the amount of stored electricity in the non-grid sources.

EMSP 36 may further comprise different optimization routines for securing the non-grid electricity. Individual optimization routines may be selected by a user as a function of what is desired to be achieved. For example, if it is necessary to shave the peaks as much as possible without concern for completely draining the non-grid electricity sources, then EMSP 36 may be configured to instruct the drawing of as much electricity as allowable from batteries 25 and photovoltaic cells 24 during the peak demand periods. Alternatively, if it is important to reserve some non-grid electricity in case a sudden unexpected peak demand occurs, then EMSP 36 may be configured to instruct the drawing of no more than a certain, preset amount of electricity from batteries 25 and/or photovoltaic cells 24 during the peak demand periods.

While the disclosure has been described in connection with specific embodiments, it is to be understood that the disclosure is not limited to these embodiments, and that alterations, modifications, and variations of these embodiments may be carried out by the skilled person without departing from the scope of the disclosure. For example, it is contemplated that the electricity management system may be configured to control the energy demand of individual energy-demanding devices at the site, so as to better manage the energy demand curve. It is furthermore contemplated that any part of any aspect or embodiment discussed in this specification can be implemented or combined with any part of any other aspect or embodiment discussed in this specification.

1. A method for managing electricity demand, the method comprising:
obtaining past demand data of a site, the past demand data comprising past electricity usage data representing electricity usage at the site over a past time period extending from a past point in time to a current point in time;
determining, based on the past demand data, projected electricity usage data of the site by inputting the past demand data to a trained machine learning model comprised in a set of one or more trained machine learning models, the projected electricity usage data representing projected electricity usage at the site over a future time period, and wherein the future time period does not comprise a period of time at least twenty-three hours from the current point in time;
determining one or more peak demand periods when, during the future time period, the projected electricity usage at the site exceeds a demand threshold; and
securing non-grid electricity for use by the site during the one or more peak demand periods.

2. (canceled)

3. The method of claim 1, wherein the trained machine learning model is configured to determine projected electricity usage data for a first time slot that immediately follows the current point in time.

4. The method of claim 3, wherein the set of trained machine learning models comprises multiple trained machine learning models, and wherein each other trained machine learning model is configured to determine projected electricity usage data for a respective time slot that immediately follows a preceding one of the time slots.

5. The method of claim 1, further comprising:
prior to obtaining the past demand data:
obtaining demand training data, the demand training data comprising electricity training data representing electricity usage at the site over a training time period greater than the past time period; and
training each machine learning model, using the demand training data, to project electricity usage at the site over first time periods as a function of electricity usage at the site over second time periods preceding the first time periods.

6. The method of claim 1, wherein the demand training data further comprises data representing one or more of: weather; temperature; humidity;
atmospheric pressure; months of a year; time of day; dates; days of a week; and whether or not a day of the week is a site holiday.

7. (canceled)

8. The method of claim 1, wherein each machine learning model comprises one or more support vector machines or a long short-term memory model.

9-10. (canceled)

11. The method of claim 1, wherein the non-grid electricity comprises electricity to be drawn from one or more batteries or from one or more photovoltaic cells.

12. The method of claim 1, wherein the past demand data further comprises data representing one or more of: weather; temperature; humidity; atmospheric pressure; date; time; and the future time period.

13-18. (canceled)

19. A demand management system for managing electricity demand, the system comprising:
one or more non-grid electricity sources; and
a control system comprising one or more processors and memory having stored thereon computer program code configured, when executed by the one or more processors, to cause the one or more processors to perform a method comprising:
obtaining past demand data of a site, the past demand data comprising past electricity usage data representing electricity usage at the site over a past time period extending from a past point in time to a current point in time;
determining, based on the past demand data, projected electricity usage data of the site by inputting the past demand data to a trained machine learning model comprised in a set of one or more trained machine learning models, the projected electricity usage data representing projected electricity usage at the site over a future time period, and wherein the future time period does not comprise a period of time at least twenty-three hours from the current point in time;
determining one or more peak demand periods when, during the future time period, the projected electricity usage at the site exceeds a demand threshold; and
securing, from the one or more non-grid electricity sources, non-grid electricity for use by the site during the one or more peak demand periods.

20. (canceled)

21. The system of claim 19, wherein the trained machine learning model is configured to determine projected electricity usage data for a first time slot that immediately follows the current point in time.

22. The system of claim 21, wherein the set of trained machine learning models comprises multiple trained machine learning models, and wherein each other trained machine learning model is configured to determine projected electricity usage data for a respective time slot that immediately follows a preceding one of the time slots.

23. The system of claim 19, wherein the method further comprises:
prior to obtaining the past demand data:
obtaining demand training data, the demand training data comprising electricity training data representing electricity usage at the site over a training time period greater than the past time period; and
training each machine learning model, using the demand training data, to project electricity usage at the site over first time periods as a function of electricity usage at the site over second time periods preceding the first time periods.

24. The system of claim 19, wherein the demand training data further comprises data representing one or more of: weather; temperature; humidity;
atmospheric pressure; months of a year; time of day; dates; days of a week; and whether or not a day of the week is a site holiday.

25. (canceled)

26. The system of claim 19, wherein each machine learning model comprises one or more support vector machines or a long short-term memory model.

27-28. (canceled)

29. The system of claim 19, wherein the non-grid electricity comprises electricity to be drawn from one or more batteries or from one or more photovoltaic cells.

30. The system of claim 19, wherein the past demand data further comprises data representing one or more of: weather; temperature; humidity; atmospheric pressure; date; time; and the future time period.

31-35. (canceled)

36. A computer-readable medium having stored thereon computer program code configured, when executed by one or more processors, to cause the one or more processors to perform a method comprising:
obtaining past demand data of a site, the past demand data comprising past electricity usage data representing electricity usage at the site over a past time period extending from a past point in time to a current point in time;
determining, based on the past demand data, projected electricity usage data of the site by inputting the past demand data to a trained machine learning model comprised in a set of one or more trained machine learning models, the projected electricity usage data representing projected electricity usage at the site over a future time period, and wherein the future time period does not comprise a period of time at least twenty-three hours from the current point in time;
determining one or more peak demand periods when, during the future time period, the projected electricity usage at the site exceeds a demand threshold; and
securing non-grid electricity for use by the site during the one or more peak demand periods.

37. (canceled)

38. The computer-readable medium of claim 36, wherein the trained machine learning model is configured to determine projected electricity usage data for a first time slot that immediately follows the current point in time.

39. The computer-readable medium of claim 38, wherein the set of trained machine learning models comprises multiple trained machine learning models, and wherein each other trained machine learning model is configured to determine projected electricity usage data for a respective time slot that immediately follows a preceding one of the time slots.

40. The computer-readable medium of claim 36, wherein the method further comprises:
prior to obtaining the past demand data:
obtaining demand training data, the demand training data comprising electricity training data representing electricity usage at the site over a training time period greater than the past time period; and
training each machine learning model, using the demand training data, to project electricity usage at the site over first time periods as a function of electricity usage at the site over second time periods preceding the first time periods.

41. The computer-readable medium of claim 36,
wherein the demand training data further comprises data representing one or more of: weather;
temperature; humidity; atmospheric pressure; months of a year; time of day; dates; days of a week; and whether or not a day of the week is a site holiday.

42. (canceled)

43. The computer-readable medium of claim 36, wherein each machine learning model comprises one or more support vector machines or a long short-term memory model.

44-45. (canceled)

46. The computer-readable medium of claim 36, wherein the non-grid electricity comprises electricity to be drawn from one or more batteries or from one or more photovoltaic cells.

47. The computer-readable medium of claim 36, wherein the past demand data further comprises data representing one or more of: weather; temperature; humidity; atmospheric pressure; date; time; and the future time period.

48-56. (canceled)
